(19) United States
(12) Patent Application Publication
(10) Pub. No.: US 2015/0145706 A1
(43) Pub. Date: May 28, 2015

(54) PIN ENTRY DEVICE, A USER IDENTIFICATION TERMINAL AND A METHOD OF OBTAINING A PIN CODE

(71) Applicants: Enis-Nuri Arif, Constanta (RO); Christophe Oger, Toulouse (FR)

(72) Inventors: Enis-Nuri Arif, Constanta (RO); Christophe Oger, Toulouse (FR)

(73) Assignee: Freescale Semiconductor, Inc., Austin, TX (US)

(21) Appl. No.: 14/402,903

(22) PCT Filed: May 30, 2012
(86) PCT No.: PCT/IB2012/001209

§ 371 Date: Nov. 21, 2014

(51) Int. Cl. G07F 7/10; G06Q 20/40

(52) U.S. Cl. CPC G07F 7/1041; G06Q 20/4012
USPC 341/23

(57) ABSTRACT

A pin entry device is described. The pin entry device has a plurality of push keys arranged to allow a user to input a pin code, a plurality of value indicators associated with the plurality of push keys, each value indicator being controllable to indicate a value of the associated push key to the user in dependence on a value assignment signal, and a key value controller arranged to dynamically generate a value assignment signal representing an assignment of a plurality of values to the plurality of push keys and provide the value assignment signal to the plurality of value indicators. A user identification terminal having such pin entry device is described, as well as a method of obtaining a pin code using such pin entry device.

### FIELD OF THE INVENTION

This invention relates to a pin entry device, a user identification terminal and a method of obtaining a pin code.

### BACKGROUND OF THE INVENTION

Safe and reliable identification of a user is an important aspect of a wide variety of systems. Identification of a user is typically performed in such systems by letting a user enter a personal identification (PIN) code on a key pad of a pin entry device and verifying the entered PIN code using a user-specific key read from, for example, a card such as a credit card—the user may then be referred to as a cardholder—, or a user-specific key stored in a system memory. An example is a point of sales (POS) terminal having a pin entry device and a card reader, allowing a cardholder to do payments from, e.g., his bank account with his bank card and the corresponding PIN code. Another example is an Automated Teller Machine (ATM) having a pin entry device and a card reader, allowing a cardholder to withdraw money from his bank account with his bank card and the corresponding PIN code. Again another example is an alarm system having a pin entry device and a system memory wherein one or more user-specific keys are stored for one or more users, allowing a user to enable and/or disable the alarm system, and hereby to, for example, control access to a building. Some of these systems, e.g., some point of sales terminals, may be operable unattended, such as an unstaffed petrol station, a ticket vendor machine. In view of security and tamper-proof requirements, such pin entry devices have a clearly defined physical and logical boundary, whereby the pin entry device is self-contained and all secure information processed therein cannot be accessed from outside; in particular, the ‘bare’ PIN code cannot be accessed from outside, not even from an application processor in, for example, the ATM, the POS terminal or alarm system, but only in encrypted form. Further, the pin entry device of known systems have for optimal tamper-resistance a key pad with push keys for PIN entry, whereas the system may have another type of user-input device, such as a touch screen, for accepting information that is less sensitive than the PIN code and does not need to be as secure as the sensitive PIN code, e.g., as to let a user of an ATM choose between whether he wishes to check the balance of his bank account or to withdraw money from his bank account. Touch screens are however not sufficiently tamper-resistant to be used in the pin entry device itself, in particular not in pin entry devices used in unattended environments. In this document, a terminal comprising a pin entry device and an application processor cooperating with the pin entry device may be referred to with the term “user identification terminal”.

A drawback of known pin entry devices is that a non-authorized person may use the pin entry device of the non-authorized person knows the pin code and, where the user of a card is requires, has obtained the card, e.g., by theft. Known pin entry devices therefor generally have a shield which aims to limit the visibility of the key pad to the user and prevent others from viewing which keys of the key pad are used to enter the PIN code. Such shield thus aims to deter the visual observation of PIN values as they are being entered by a cardholder, However, a careful observation by the non-authorized person of the gestures of the authorized user may still allow the non-authorized person to reconstruct which PIN code the authorized user has used.

An example of a user identification terminal 6P is shown in FIG. 1. The user identification terminal 6P comprises a pin entry device 1P and a host processor 2 (also referred to as HOST). The pin entry device 1P comprises a pin pad 10P and a pin pad controller 16 (also referred to as ACON). The pin pad controller 16 and the host processor HOST are arranged to communicate a control signal via a control signal line 3C from the host processor 2 to the pin pad controller 16 of the pin entry device 1P and to communicate an encrypted pin signal via a pin signal line 3P from the pin pad controller ACON to the host processor HOST. The pin pad 10P comprises an array 14P of twelve push keys, arranged in 4 rows of 3 keys each. The twelve push keys may be individually referred to by to by indexing them with indices 1 to 12 from top left to bottom right as 14P(1), . . . 14P(12). Each push key 14P(1), . . . , 14P(12) indicates a respective value according to a fixed scheme, with the three push keys 14P(1), . . . , 14P(3) of the top row indicating values ‘1’, ‘2’ and ‘3’, the three push keys 14P(4), . . . , 14P(6) of the second row indicating values ‘4’, ‘5’ and ‘6’, the three push keys 14P(7), . . . , 14P(9) of the third row indicating values ‘7’, ‘8’ and ‘9’, the central push key 14P(11) of the lower row indicating value ‘0’, and the left and right push keys 14P(10) and 14P(12) indicating additional symbols, such as ‘*’ or ‘#’, as shown in FIG. 1. The pin pad 10P further comprises a display 12 (also referred to as DISP) for displaying messages to the user such as instruction messages as “ENTER PIN” and status messages as “OK”, “WRONG” or “CANCELLED”. The pin pad 10P is arranged to communicate with the pin pad controller ACON with a pad control signal 16C from the pin pad controller ACON to the pin pad 10P to, e.g., activate and initialize the pin pad 10P or to operate the display DISP of the pin pad 10P to show a specific message. The pin pad 10P is further arranged to communicate with the pin pad controller ACON with a bare pin value signal 16P from the pin pad 10P to the pin pad controller ACON to indicate the values of the key(s) that have been pressed. The pin pad controller ACON is arranged to receive the bare pin value signal 16P for a sequence of key presses as a bare pin signal and encrypts the bare signal to obtain the encrypted pin signal and supply the encrypted pin signal to the pin signal line 3P. The pin entry device 1P further comprises a plastic cover shield 11 that extends away from the pin entry device 1P towards the user to deter visual observation of PIN values by another observer as the PIN values are being entered by a cardholder on the array 14P, while at the same time allowing the cardholder to view the array 14P of push keys 14P(1), . . . , 14P(12). The plastic cover shield 11 may as a result be only partially effective to prevent the another observer to recover the PIN values, either directly from key presses the or from observing the gestures from the cardholder.

### SUMMARY OF THE INVENTION

The present invention provides a pin entry device, a user identification terminal and a method of obtaining a pin code as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 schematically shows an example of a prior art pin entry device;

FIG. 2 schematically shows an example of an embodiment of a user identification terminal comprising an exemplary embodiment of a pin entry device;

FIG. 3-FIG. 6 schematically show examples of details of embodiments;

FIG. 7 schematically shows an example of another embodiment of a user identification terminal comprising an alternative exemplary embodiment of a pin entry device;

FIG. 8 schematically shows an example of an embodiment of a method;

FIG. 9a-FIG. 9d schematically show examples of different key assignments usable in embodiments; and

FIG. 10 schematically shows an example of an embodiment of an ATM.

### DETAILED DESCRIPTION OF THE PREFERRED EMBODIMENTS

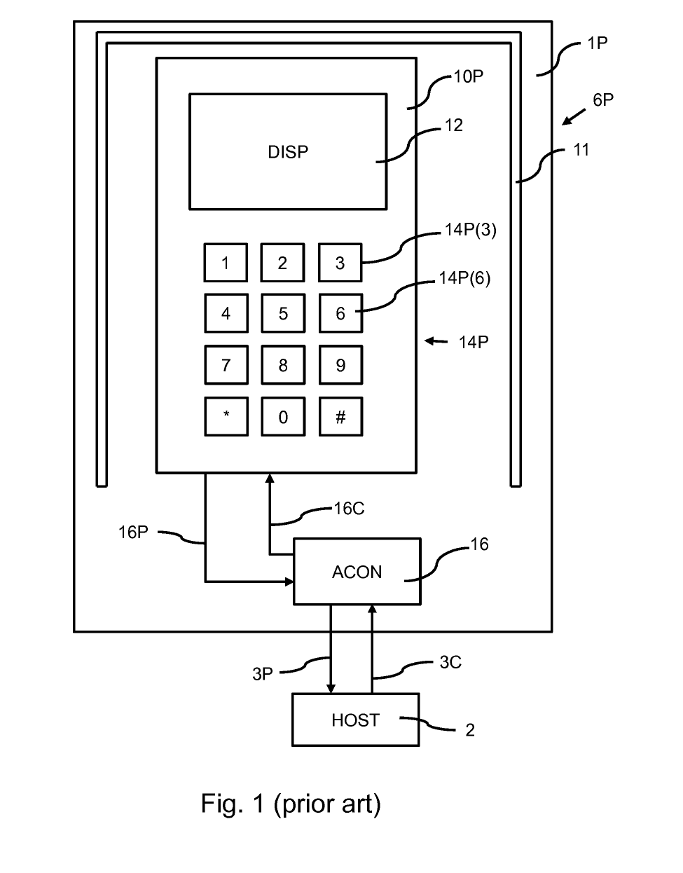

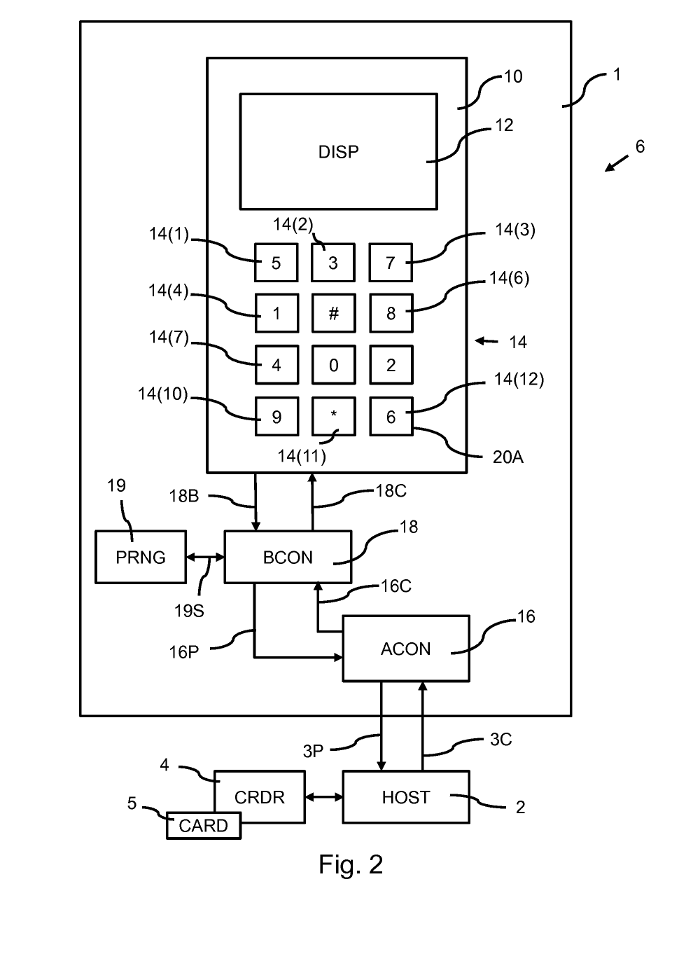

FIG. 2 schematically shows an example of an embodiment of a user identification terminal 6 having a pin entry device 1 according to an exemplary embodiment and a host processor 2 (also referred to as HOST). The host processor HOST may be the same as in the known user identification terminal 6P of FIG. 1, and is therefore indicated with the same reference symbols (2 and HOST). The pin entry device 1 comprises a pin pad 10 and a pin pad controller 16 (also referred to as ACON). The pin pad controller 16 ACON may be the same as in the known user identification terminal 6P of FIG. 1, and is therefore indicated with the same reference symbols (16 and ACON). The pin pad controller 16 and the host processor HOST are arranged to communicate a control signal via a control signal line 3C from the host processor 2 to the pin pad controller 16 of the pin entry device 1 and to communicate an encrypted pin signal via a pin signal line 3P from the pin pad controller ACON to the host processor HOST. The pin pad 10 comprises an array 14 of twelve push keys, arranged in four rows of three push keys each. The twelve push keys may be individually referred to by indexing them with indices 1 to 12 from top left to bottom right as 14(1), . . . 14(12). Each push key 14(1), . . . , 14(12) is arranged to indicate a dynamically assigned value using a respective plurality of value indicators, of which the value indicator associated with push key 14(12) is indicated in FIG. 2 with reference sign 20A. Each value indicator is controllable to indicate a value of the associated push key to the user in dependence on a value assignment signal. Hereto, the pin pad 10 comprises a key value controller 18 (also referred to as BCON) arranged to dynamically generate a value assignment signal 18C representing an assignment of a plurality of values to the plurality 14 of push keys and provide the value assignment signal to the plurality of value indicators 20A associated with the plurality of push keys 14(1), . . . , 14(12). Each push key 14(1), . . . , 14(12) thus indicates a respective value according to a dynamic scheme. For example, at one instance as shown in FIG. 2, the three push keys 14(1), . . . , 14(3) of the top row indicate values ‘5’, ‘3’ and ‘7’, the three push keys 14(4), . . . , 14(6) of the second row indicate values ‘1’, ‘#’ and ‘8’, the three push keys 14(7), . . . , 14(9) of the third row indicate values ‘4’, ‘0’ and ‘2’, the three push keys 14(10), . . . , 14(12) of the lower row indicate values ‘9’, ‘*’ and ‘6’. The pin pad 10 further comprises a display 12 (also referred to as DISP) for displaying messages to the user such as instruction messages as “ENTER PIN” and status messages as “OK”, “WRONG” or “CANCELLED”. The pin pad 10 is thus arranged to communicate with the key value controller BCON with the value assignment signal 18C from the key value controller BCON to the pin pad 10. The line arranged to carry the value assignment signal may further be used to, e.g., activate and initialize the pin pad 10 or to operate the display DISP of the pin pad 10 to show a specific message. The pin pad 10 is further arranged to communicate with the key value controller BCON and via a key press signal 18B from the pin pad 10 to the key value controller BCON to indicate which key(s) have been pressed. The key value controller BCON is arranged to receive the key press signal 18B for a sequence of key presses and to reconstruct the value of the associated key press using the value assignment signal(s), to obtain a bare pin value signal 16P from the key press signal 18B. The pin pad 10 and the key value controller BCON cooperate to communicate with the pin pad controller ACON via a pad control signal 16C from the pin pad controller ACON to the pin pad 10 to, e.g., activate and initialize the pin pad 10 or to operate the display DISP of the pin pad 10 to show a specific message. The key value controller BCON is arranged to communicate with the pin pad controller ACON to provide the bare pin value signal 16P to the pin pad controller ACON to indicate which values have been entered. The pin pad controller ACON is arranged to receive the bare pin value signal 16P for a sequence of key presses as a bare pin signal and encrypts the bare signal to obtain the encrypted pin signal and supply the encrypted pin signal to the pin signal line 3P. The pin entry device 1 may be arranged to generate a new assignment of values to push keys for each next PIN entry based on the pad control signal 16C. The pin entry device 1 may alternatively or additionally be arranged to generate a new assignment of values to push keys in response to a user request, e.g., by a user pressing a dedicated key (not shown) or by the user pressing the ‘#’ key. Hereto, the key value controller BCON may be being arranged to, after having generated the value assignment signal representing an assignment of the plurality of values to the plurality of push keys for a first time, generate the value assignment signal again, but representing a different assignment of the plurality of values to the plurality of push keys. The key value controller BCON may be arranged to maintain the assignment until a complete pin code is entered. Alternatively, the key value controller BCON may, e.g., be arranged to change the assignment after each entry of a digit of a complete pin code.

Thus, the push keys may have dynamically assigned values and indicate the dynamically assigned values using the respective value indicators, while maintaining the robustness and other characteristics that are associated with push keys. The dynamic assignment of the values prevents an observer to reconstruct the values of the key presses from gestures only, as the same gesture may correspond to another value. For example, whereas a gesture corresponding to pushing the middle key 14P(5) of the second row always corresponds to a value 5 in the known pin entry device 1P shown in FIG. 1, the same gesture corresponds to another value with the pin entry device 1 according to the exemplary embodiment: in the exemplary assignment in FIG. 2, this gesture corresponds to a ‘#’. For example, where an observer would expect the entered PIN code being ‘6128’ based on the fixed value layout of the prior art and a sequence of key presses {14P(6), 14P(1), 14P(2), 14P(8)}, the entered PIN code with the assignment of FIG. 2 would, for the corresponding sequence of key presses {14(6), 14(1), 14(2), 14(8)} be ‘8530’. In the embodiment shown, the pin pad comprises twelve push keys and a corresponding plurality of in total twelve values consisting of ‘0’-‘9’, ‘#’ and ‘*’ are dynamically assigned to the push keys. In alternative embodiments, only numerical values ‘0’-‘9’ are dynamically assigned. The plurality of push keys may correspond to the plurality of values which are dynamically assigned. In alternative embodiments, the plurality of push keys may be larger than the plurality of values assigned. In further embodiments, one value may be assigned to multiple push keys and/or one or more push keys may have no values assigned to it (which may be referred to as an ‘empty’ push key)

FIG. 2 further shows that the host processor 2 may be in communication with a card reader 4 (also referred to as CRDR). The card reader CRDR is arranged to receive a credit card 5 (also referred to as CARD), to read a pin value from the card and to supply the pin value to the host processor HOST, allowing the host processor to verify the integrity of the pin code entered by the user, and concluding that the user is the true cardholder of the pin code entered by the user matches with the pin code read from the card. The skilled person will appreciate that the pin code may be retrieved in encrypted form from the card.

FIG. 2 thus shows an example of a pin entry device 1 comprising a plurality of push keys 14 arranged to allow a user to input a pin code; a plurality of value indicators associated with the plurality of push keys, each value indicator being controllable to indicate a value of the associated push key to the user in dependence on a value assignment signal; and a key value controller BCON arranged to dynamically generate a value assignment signal 18C representing an assignment of a plurality of values to the plurality of push keys and provide the value assignment signal to the plurality of value indicators.

The key value controller BCON may be arranged to cooperate with, or comprise, a random number generator or a pseudo random number generator PRNG arranged to generate a random number in response of a request of the key value controller, the key value controller being arranged to generate the value assignment signal in response of the random number.

The key value controller BCON may be arranged to receive the key press signal 18B representing which key of the plurality of the push keys are pressed by the user and determine a corresponding value from the key press signal and the assignment of the plurality of values to the plurality of push keys.

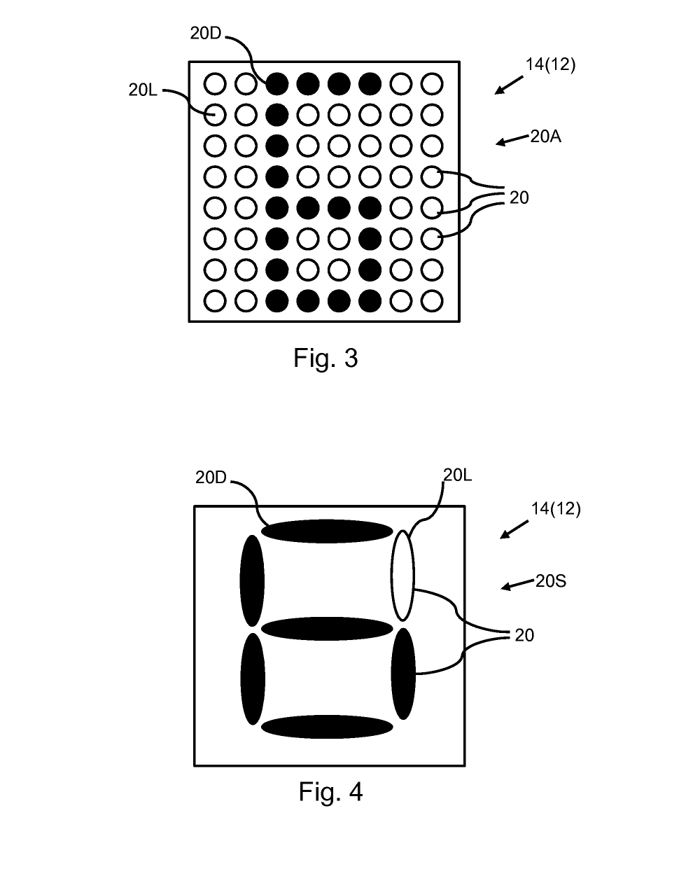

FIG. 3 schematically shows an example of a value indicator 20A. Alternative value indicators 20S, 20BA, 20SBA are shown in FIG. 4-FIG. 6.

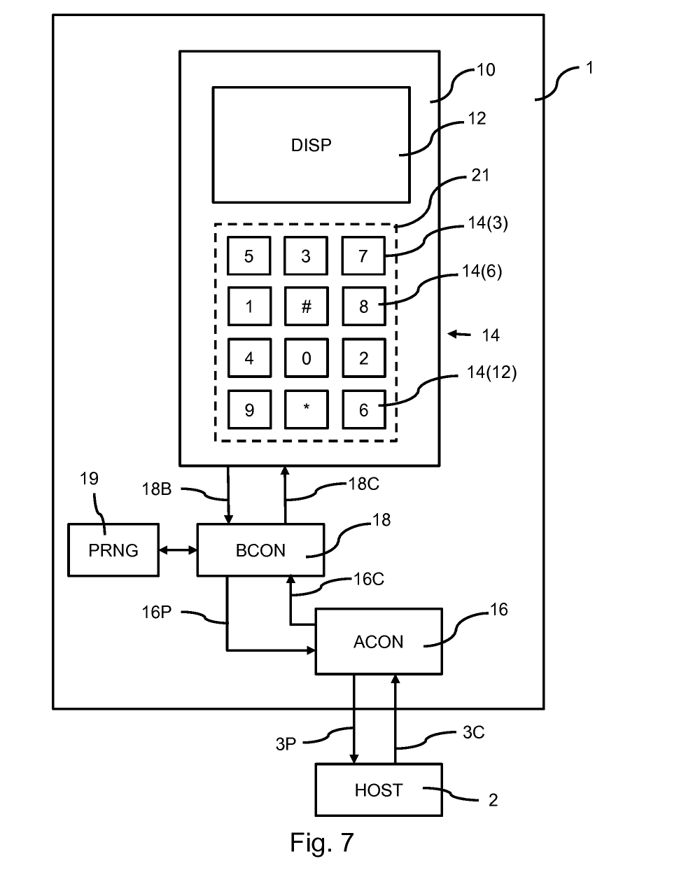

The value indicators 20S, 20BA and 20SBA are arranged to provide a visual indication. Hereto, each value indicator may comprise a visual display operable to indicate the value of the associated push key in a manner perceivable by vision. The value indicators may thus dynamically indicate the value associated with the push key. In embodiments, the push keys may be at least in part transparent and the visual display may be arranged behind the associated push key to allow the user to view the visual display through the associated push key. The display may hereby be stationary in position while the push key itself is displaced by being pressed. FIG. 7 shows a further embodiment, wherein the visual displays of the plurality of value indicators are parts of a single integral display 21.

The value indicators 20BA and 20SBA are arranged to provide a tactile indication. The tactile indication allows visually impaired to use the dynamically operated pin entry device. Hereto, each value indicator 20BA 20SBA may comprise a tactile renderer operable to indicate the value of the associated push key in a manner perceivable by touch. For example, the tactile renderer may be arranged to render a Braille cell to indicate the value of the associated push key. The value indicator 20SBA is arranged to provide a visual indication as well as a tactile indication. The value indicators 20A20S, 20BA, 20SBA are shown for push key 14(12) while a value of ‘6’ is assigned to push key 14(12). The skilled person will appreciate how the value indicators operate for other values.

The example of FIG. 3 shows push key 14(12) and an associated value indicator in the form of a matrix display 20A. The matrix display 20A comprises a plurality of pixels 20 arranged in a matrix, which pixels can be selectively driven so as to indicate the value assigned to the push key 14(12). For example, the value ‘6’ can be presented by driving the pixels to be dark as shown for pixel 20D or bright as shown for pixel 20L. Each push key may comprise an individual matrix display. The matrix display could e.g. be a light emitting diode (LED) array, a liquid crystal display (LCD display), a electroluminescent (EL) display, a paper-like display such as an electronic ink display, or any other suitable type of matrix display. The matrix display may be of active matrix, or alternatively of passive matrix, type.

The example of FIG. 4 shows push key 14(12) and an associated value indicator in the form of a segment display 20S. The segment display 20S could e.g. be a light emitting diode (LED) array, a liquid crystal display (LCD display), a electroluminescent (EL) display, a paper-like display such as an electronic ink display, or any other suitable type of segment display. The segment display 20S may be a 7-segment display as shown in FIG. 4, e.g., if only numerical values need to be displayed. If also other values, such as ‘#’ and/or ‘*’, need to be displayed, the segment display may have more segments so as to be able to display symbols graphically representing these values ‘#’ and/or ‘*’.

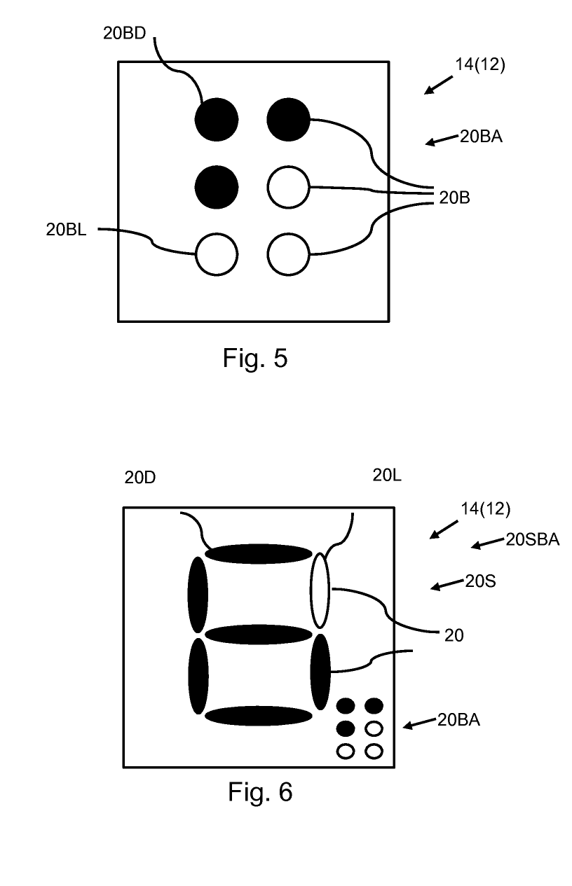

The example of FIG. 5 shows push key 14(12) and an associated value indicator in the form of a tactile renderer 20BA arranged to render a Braille cell to indicate the value of the associated push key. The tactile renderer 20BA may e.g. be a tactile Braille renderer, such as a needle bed comprising six needles extending through a reference surface which can be controlled to be raised or leveled relative to the reference surface by respective actuators, to hereby render Braille symbols corresponding to the assigned value. For example, the value ‘6’ may be indicated while raising the needles indicated in dark 20BD and levelling needles indicated in white 20BL as shown in FIG. 5. Tactile Braille renderers are known e.g. as text output devices from computers and may be adapted to be suitable for a pin entry device.

The example of FIG. 5 shows push key 14(12) and an associated value indicator in the form of combination of a segment display 20S and a tactile renderer 20BA. The tactile renderer 20BA may be similar to the one shown in FIG. 5, but of a smaller size such that it may e.g. be fitted in a corner of the associated push key. Hereby, a pin entry device with dynamic value assignment may be provided that is suitable for use by viewing as well as by visually impaired users.

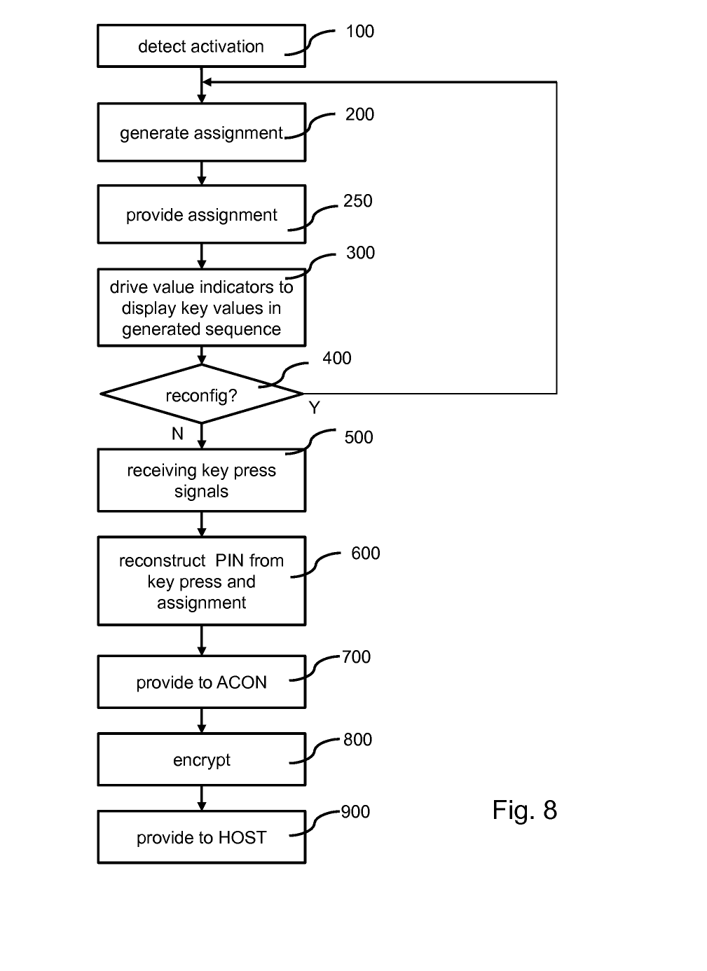

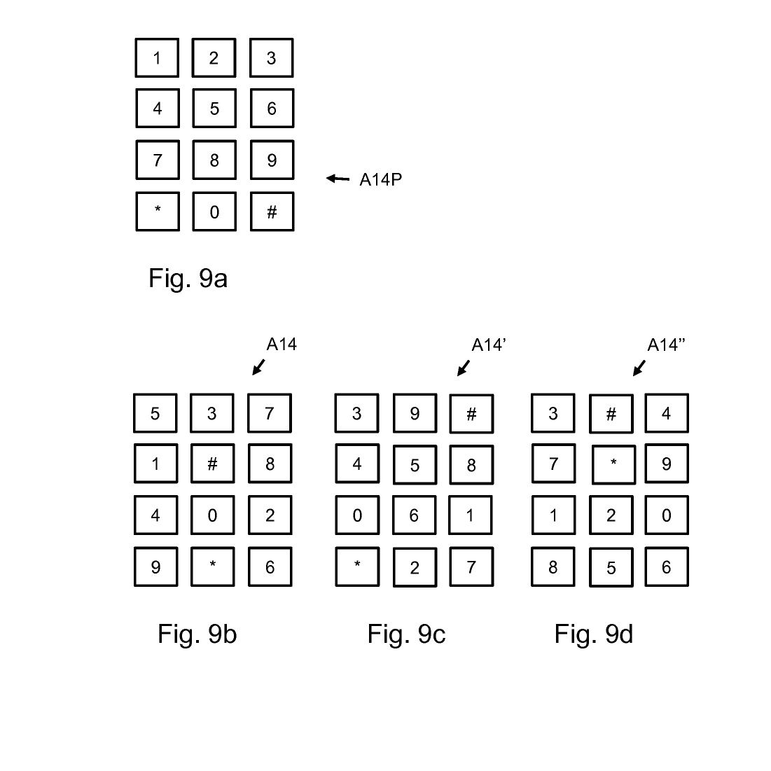

FIG. 8 schematically shows an example of an embodiment of a method of obtaining a pin code from a user using a pin entry device. The method comprises a first action 100 comprising detecting an activation. The skilled person will appreciate that many suitable methods for detecting the activation of a pin entry device, of a user identification terminal, or of a system comprising a user identification terminal are known. For example, detecting the activation may comprise detecting, by the pin entry device, a first key press of any push key of the plurality of push keys. As another example, detecting the activation may comprise detecting, by a user identification terminal comprising a pin entry device and a card reader, an insertion of a card into the card reader. After the activation is detected, a second action 200 comprises dynamically generating 200 a value assignment signal 18C representing an assignment of a plurality of values to the plurality of push keys of the pin entry device. The plurality of values may comprise all numerical values from ‘0’ to ‘9’ and the generating may comprise assigning each of these numerical values to one respective push key in dependence on a random number generated from a random number generator or a pseudo random number generator. The generating may comprise selecting an assignment from a plurality of pre-determined assignments. Examples of assignments are schematically indicated in FIGS. 9a-9d, which are discussed below. After the assignment signal 18C is generated, a next action 250 comprises providing 250 the value assignment signal to the plurality of value indicators of the pin entry device. Next, a third action 300 comprises controlling the value indicators of the pin entry device to indicate values of the associated push keys in dependence on the value assignment signal. For example, where the value indicators comprise respective segment displays, such as shown in FIG. 6, the segment displays of the associated push keys are controlled with a drive signal in correspondence with the value as indicated by the value assignment signal. The method may comprise an optional action 400 of checking whether a reconfiguration of the assignment needs to be performed. Hereto, the method may e.g. detect whether the user presses a reconfiguration button. If a reconfiguration is to be performed, the method returns to the second action 200 and generates a next value assignment signal 18C representing a different assignment of the plurality of values to the plurality of push keys of the pin entry device. If no reconfiguration is to be performed, the method continues to a next action 500 comprising receiving a sequence of key press signals 18B representing which keys of the plurality of the push keys are pressed by the user. The key press signals 18B may represent which push key(s) were pressed, and may be ignorant of the value assigned to the respective push key(s). After a sequence of key press signals is received, the method proceeds with obtaining 600 the pin code from, for the sequence of key press signals, determining a corresponding sequence of values from the key press signals and the assignment of the plurality of values to the plurality of push keys. The method may further comprise providing 700 the pin code as a bare pin value signal to the pin pad controller ACON. The method may further comprise encrypting 800 the bare signal to obtain an encrypted pin signal and supplying 900 the encrypted pin signal to a host controller. The host controller may then verify the integrity of the pin code as entered by the user by verifying the encrypted pin signal, e.g., by checking whether the encrypted pin signal matches with a pin code retrieved from a card, as in an ATM or a POS terminal, or with a pin code retrieved from a memory, as in an alarm system.

FIG. 9a-FIG. 9d schematically show examples of the plurality of push keys indicating different key assignments. FIG. 9a shows a key assignment A14P corresponding to the layout of values in a prior art pin entry device, with fixed values for each push key. Thus, the values ‘0’, ‘1’, ‘2’, ‘3’, ‘4’, ‘5’, ‘6’, ‘7’, ‘8’, ‘9’, ‘*’ and ‘#’ are assigned to the plurality 14 of push keys as ‘0’:14(11), ‘1’:14(1), ‘2’:14(2), ‘3’:14(3), . . . , ‘9’:14(9), ‘*’:14(10) and ‘#’:14(12). FIG. 9b-9d schematically show three exemplary key assignments A14, A14′ and A14″, that could subsequently be generated by the key value controller BCON and presented by the value indicators associated with the push keys. For example, in assignment A14, the values ‘0’, ‘1’, ‘2’, ‘3’, ‘4’, ‘5’, ‘6’, ‘7’, ‘8’, ‘9’, ‘*’ and ‘#’ are assigned to the plurality 14 of push keys as ‘0’:14(8), ‘1’:14(4), ‘2’:14(9), ‘3’:14(2), ‘4’:14(7), ‘5’:14(1), ‘6’:14(12), ‘7’:14(3), ‘8’:14(6), ‘9’:14(10), ‘*’:14(11) and ‘#’:14(5). In assignment A14′, the values ‘0’, ‘1’, ‘2’, ‘3’, ‘4’, ‘5’, ‘6’, ‘7’, ‘8’, ‘9’, ‘*’ and ‘#’ and # are assigned to the plurality 14 of push keys differently as ‘0’:14(7), ‘1’:14(9), ‘2’:14(11), ‘3’:14(1), ‘4’:14(12), ‘5’:14(5), ‘6’:14(8), ‘7’:14(12), ‘8’:14(6), ‘9’:14(2), ‘*’:14(10), ‘#’:14(3). In assignment A14″, the values ‘0’, ‘1’, ‘2’, ‘3’, ‘4’, ‘5’, ‘6’, ‘7’, ‘8’, ‘9’, ‘*’ and ‘#’ are assigned to the plurality 14 of push keys again differently as ‘0’:14(9), ‘1’:14(7), ‘2’:14(8), ‘3’:14(1), ‘4’:14(3), ‘5’:14(11), ‘6’:14(12), ‘7’:14(3), ‘8’:14(10), ‘9’:14(2), ‘*’:14(5) and ‘#’:14(2).

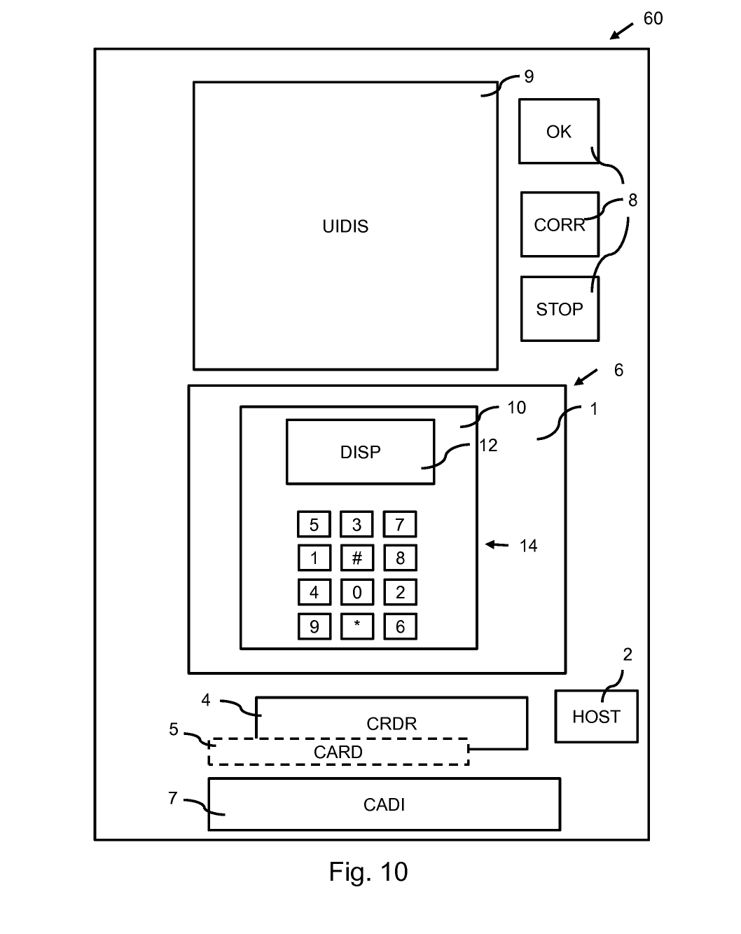

FIG. 10 schematically shows an example of an embodiment of an Automated Teller Machine (ATM) 60 comprising an example of a user identification terminal 6. The user identification terminal 6 comprises a pin entry device 1 according to an embodiment, a host 2 and a card reader 4 for reading a pin value from a card 5 while the card is offered to the card reader. The host 2 may be being arranged to verify a cardholder's identify by comparing the pin code entered by the user using the pin entry device 1 to the pin value read from the card using the card reader 4. The ATM 60 further comprises a cash dispenser 7 (also referred to as CADI) arranged to dispense an indicated amount of money to the cardholder after the cardholder's identify is positively verified. The ATM 60 further comprises a user interface display 9 (also indicated as UIDIS) allowing to present graphical and textual images to the user, such as a welcome screen and a menu. The user interface display 9 may be a touch screen, as the user interface display 9 has no direct influence on the secure part of the system, i.e., on the pin entry device 1, such that some compromises may be made as to its tamper-resistance. The ATM 60 further comprises a plurality of main control buttons 8 to provide main control by the user of the ATM, such as a confirmation button indicated with reference sign OK, a correction button indicated with reference sign CORR and a cancellation button indicated with reference sign STOP.

An alternative user identification terminal 6 may comprises a pin entry device 1 according to an embodiment, a host 2 and a system memory readable to retrieve a pin value, the host 2 being arranged to verify a user's identify by comparing the pin code entered by the user using the pin entry device (1) to the pin value read the system memory. The user identification terminal may e.g. be an access terminal of an alarm system.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be an type of connection suitable to transfer signals from or to the respective nodes, units or devices, for example via intermediate devices. Accordingly, unless implied or stated otherwise the connections may for example be direct connections or indirect connections.

The conductors (which may alternatively be referred to as lines or signal lines) as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Although the invention has been described with respect to specific conductivity types or polarity of potentials, skilled artisans appreciated that conductivity types and polarities of potentials may be reversed.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between some of the logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Also, devices functionally forming separate devices may be integrated in a single physical device. For example,

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A pin entry device comprising:
a plurality of push keys arranged to allow a user to input a pin code;
a plurality of value indicators associated with the plurality of push keys, each value indicator being controllable to indicate a value of the associated push key to the user in dependence on a value assignment signal; and
a key value controller arranged to dynamically generate a value assignment signal representing an assignment of a plurality of values to the plurality of push keys and provide the value assignment signal to the plurality of value indicators.

2. A pin entry device according to claim 1, wherein each value indicator is arranged to provide a visual indication.

3. A pin entry device according to claim 2, wherein each value indicator comprises a visual display operable to indicate the value of the associated push key in a manner perceivable by vision.

4. A pin entry device according to claim 3, wherein the display is a segment display.

5. A pin entry device according to claim 3, wherein the display is a matrix display.

6. A pin entry device according to claim 3, wherein the push keys are at least in part transparent and the visual display is arranged behind the associated push key to allow the user to view the visual display through the associated push key.

7. A pin entry device according to claim 6, wherein the visual displays of the plurality of value indicators are parts of an integral display.

8. A pin entry device according to claim 2, wherein each value indicator is arranged to provide a tactile indication.

9. A pin entry device according to claim 8, wherein each value indicator comprises a tactile renderer operable to indicate the value of the associated push key in a manner perceivable by touch.

10. A pin entry device according to claim 9, wherein the tactile renderer is arranged to render a Braille cell to indicate the value of the associated push key.

11. A pin entry device according to claim 1, wherein each of the value indicators is integrated in the associated push key.

12. A pin entry device according to claim 1, further comprising a random number generator or a pseudo random number generator arranged to generate a random number in response of a request of the key value controller, wherein the key value controller is arranged to generate the value assignment signal in response of the random number.

13. A pin entry device according to claim 1, wherein the key value controller is arranged to receive a key press signal representing which key of the plurality of the push keys are pressed by the user and determine a corresponding value from the key press signal and the assignment of the plurality of values to the plurality of push keys.

14. A pin entry device according to claim 13, comprising a device controller arranged to
receive the corresponding values for a series of key press signals,
determine an encrypted PIN signal from the corresponding values and an encryption key received from a host, and
provide the encrypted PIN signal to the host.

15. A pin entry device according to claim 1, wherein the key value controller is arranged to, after having generated the value assignment signal representing an assignment of the plurality of values to the plurality of push keys for a first time, generate the value assignment signal again, but representing a different assignment of the plurality of values to the plurality of push keys.

16. A pin entry device according to claim 1, wherein the key value controller is arranged to maintain the assignment until a complete pin code is entered.

17. A pin entry device according to claim 1, wherein the key value controller is arranged to change the assignment after each entry of a digit of a complete pin code.

18. A user identification terminal comprising:
a pin entry device according to claim 1,
a host, and
one of a card reader for reading a pin value from a card while the card is offered to the card reader or a system memory readable to retrieve a pin value from the system memory, wherein the host is arranged to verify a cardholder's identify by comparing the pin code entered by the user using the pin entry device to the pin value read from the card using the card reader or retrieved from the system memory.

19. A user identification terminal according to claim 18, wherein the user identification terminal is one of an unattended user identification terminal suitable to be operated in at least one of an ATM, an unattended point of sales terminal such as an automatic fuel dispenser or a ticket machine, or an alarm system.

20. (canceled)
